(19) United States
(12) Patent Application Publication
(10) Pub. No.: US 2013/0099756 A1
(43) Pub. Date: Apr. 25, 2013

(54) BACKUP POWER SUPPLY SYSTEMS AND METHODS

(71) Applicants: David Paul Mohr, Spring, TX (US); Daniel Humphrey, Houston, TX (US); Zachary J. Gerbozy, Spring, TX (US)

(72) Inventors: David Paul Mohr, Spring, TX (US); Daniel Humphrey, Houston, TX (US); Zachary J. Gerbozy, Spring, TX (US)

(73) Assignee: HEWLETT-PACKARD DEVELOPMENT COMPANY, L.P., Houston, TX (US)

(21) Appl. No.: 13/808,132

(22) PCT Filed: Oct. 26, 2010
(86) PCT No.: PCT/US2010/053942

§ 371 Date: Jan. 3, 2013

(51) Int. Cl. H02J 7/00; H02J 9/00

(52) U.S. Cl. CPC H02J 7/0068; H02J 9/00
USPC 320/134; 307/66

(57) ABSTRACT

Backup power supply systems and methods are disclosed. An exemplary method includes providing at least one battery module having a first register with at least one battery parameter. The method also includes coupling an intelligent interface converter (IIC) between the at least one battery module and an electrical load, the IIC having a second register with at least one battery parameter. The method also includes communicating the at least one battery parameter to a user for reporting and management operations.

### BACKGROUND

Backup power supply or Uninterruptible Power Supply (UPS) devices are commonly available for computer systems and other electronic devices where uninterrupted power is desired (e.g., to continue providing power during a power outage). The UPS device replaces or supplements electrical power from the utility company with electrical power from a battery (or batteries) in the UPS device. The battery is able to provide power at least for a limited time, until electrical power from the utility provider can be restored. Once electrical power is restored, the electrical power is used to recharge the battery in the UPS device so that the battery is fully charged the next time there is a power outage.

UPS devices are commonly utilized for large datacenters. However, the UPS devices are not scalable to accommodate growing power demand. Changes to the datacenter power demand often translate to significant investment of capital to add UPS devices. Instead, UPS device are typically sized for the total expected power requirement of the datacenter. But this approach increases initial capital expenditures for a UPS device that can accommodate datacenter equipment that may still be years away from being purchased. In addition, the oversized UPS device may not operate efficiently until the datacenter is brought up to full capacity, thereby imposing unnecessary operating expense early on. The oversized UPS device also consumes “real estate” at the datacenter which then cannot be used for other purposes.

### BRIEF DESCRIPTION OF THE DRAWINGS

FIG. 1 is a plan view of an example backup power system as it may be implemented in a rack system.

FIG. 2a is an example of a power map for the backup power system. FIG. 2b is an example of a communication map for the backup power system.

FIG. 3 is a flowchart showing example operations which may be implemented for controlling a backup power system.

FIGS. 4a-b are flowcharts showing example operations of an intelligent interface converter (IIC).

FIGS. 5a-b are flowcharts showing example operations of an interface and management (IM).

### DETAILED DESCRIPTION

Backup power supply systems and methods are disclosed. In an embodiment, the backup power supply system is modular and thus can be purchased and brought online over time as the datacenter is populated with electronic devices, thereby reducing up-front capital expenditures. In addition, the backup power supply system may be sized more closely to the load, increasing operating efficiency for the life of the product. The distributed nature of the backup power supply system also frees up “real estate” in the data center for more electronics.

Embodiments of the backup power supply system disclosed herein also implement customization. That is, traditional UPS systems do not discriminate between devices on the load. That is, when the power fails, the UPS system provides backup power to any device connected to the UPS system. This includes even the least important electronics, and thus can lead to over-sizing the UPS system in order ensure that all of the electronics are provided with sufficient backup power during the power failure. Of course, some of the electronics (e.g., some display devices and backup systems) do not need to be operated during a power failure, and therefore do not need to be provided with power from the UPS system. The backup power supply system disclosed herein enables customized ride through times and power levels for different electronics devices. Less important electronics may be allowed to power off during a power failure so that the backup power supply system only has to provide power to the more important electronics.

Embodiments of the backup power supply system disclosed herein also include higher efficiencies. That is, traditional UPS systems also operate to provide AC power. The power conversion from DC to AC results in losses which are compensated for by providing additional energy storage for the UPS system. In addition, operating with AC introduces harmonic, power factor, peak current and other issues that can rob the system of backup capacity. The backup power supply system disclosed herein implements a DC rail. This eliminates 10 to 20% of the required energy storage for AC to DC conversion losses. Accordingly, the backup power supply system disclosed herein operates more efficiently. Example standby efficiencies may be in excess of 99.75%; backup or discharge efficiencies may be in excess of 95%; and charging efficiencies may be in excess of 97%.

The backup power supply system also uses smaller, less expensive components which reduces cost and increases margin. In addition, in the event of a failure of one component (e.g., a battery module), only a selected domain is lost, and there is less chance for a total loss of operating capacity at the datacenter (as opposed to a central UPS device). It is also less expensive to warranty the backup power supply system because the replaceable part (e.g., the battery module) is only a small piece of the overall solution.

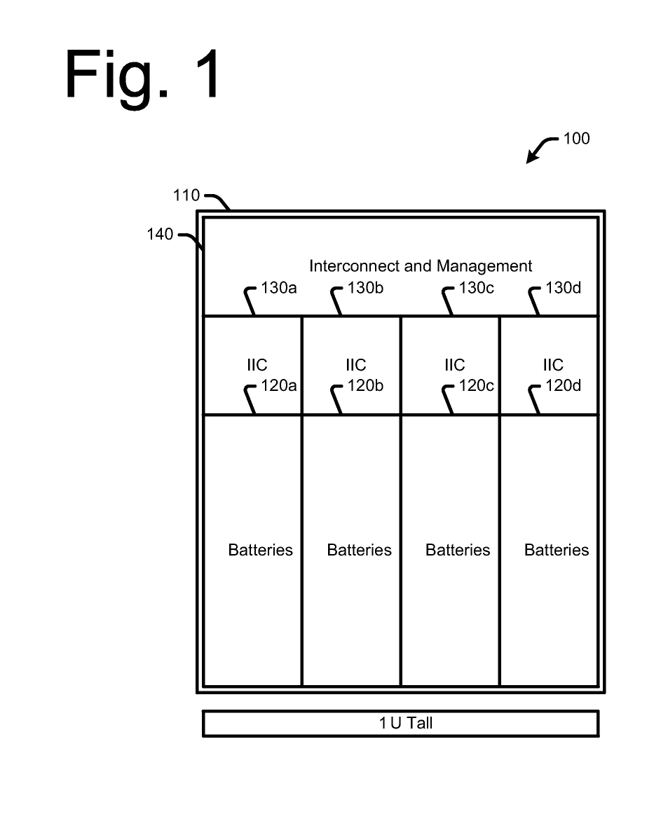

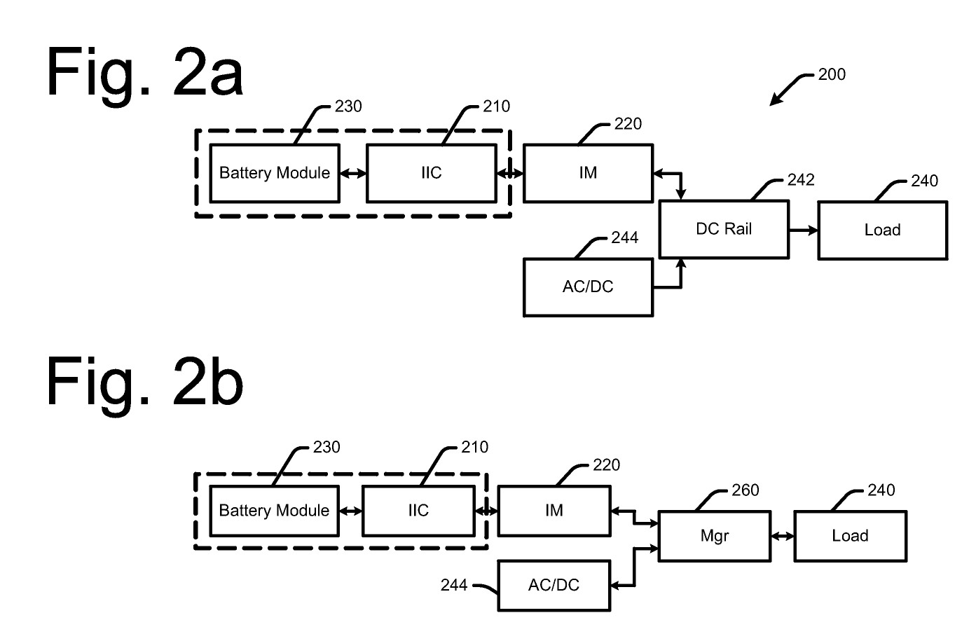

FIG. 1 is a plan view of an example backup power system 100 as it may be implemented in a rack system. The backup power system 100 may also be referred to herein as an Uninterruptible Power Supply (UPS) device, although the backup power system 100, even when referred to as a UPS device, is different than traditional UPS devices for reasons which will become apparent from the following description of the various embodiments.

The UPS device 100 may include a primary unit 110 housing an auxiliary power source, such as a battery or battery modules 120a-d. Although four battery modules 120a-d are shown in FIG. 1, it is noted that any number of battery modules may be provided. In addition, each battery module 120a-d may include one or more battery packs.

The primary unit 110 may also include a number of intelligent interface converters (IIC) 130a-d. In an embodiment, one IIC 130a-d is provided for each corresponding battery module 120a-d, although in other embodiments, there need not be a 1:1 correlation. For example, in another embodiment, a single IIC may be provided for two or more battery modules of the same type. The IIC 130a-d are each connected to an interconnect and management (IM) board 140. The IM 140 interfaces the battery modules with the power system, as described below with reference to FIGS. 2a-b.

The backup power system 100 may be used to power a single IT enclosure, a rack of IT enclosures, or racks of IT enclosures. In an example, each primary unit 110 is sized to fit within a rack environment, and multiple, distributed primary units (not shown) may be provided in a single IT enclosure, for an entire rack of IT enclosures, or in separate racks of IT enclosures. In the example shown in FIG. 1, the primary unit 110 is sized to be 1 U tall. However, other embodiments of sizes for the primary unit 110 are also contemplated and the backup power supply system 100 is not limited to any particular size. Sizing may depend on a wide variety of design considerations, such as the size battery modules being used, the desired backup power, and/or the overall size of the backup power supply system, to name only a few examples of design considerations.

FIG. 2a is an example of a power map 200 for the backup power supply system (e.g., 100 shown in FIG. 1). As mentioned above, the backup power supply system includes one or more IIC 210 and one or more IM 220. The battery module(s) 230 interfaces with the IIC 210, and the IIC 210 interfaces the battery module 230 to the load 240.

In an embodiment, a common interface is provided between the IIC 210 and the battery module 230. This common interface enables use of a wide variety of different battery technologies (e.g., different cell chemistry), as well as any number of cells. The IIC 210 also connects to a common DC rail 242 through the power interface. The DC rail 242 may also be connected to a primary electrical power source via AC/DC converter, such as a wall outlet providing AC electrical power from the utility company. The DC rail 242 serves to provide a consistent power source to the load 240, providing advantages such as those already discussed above, in addition to electrically isolating the backup power supply system from the AC power source (taking the backup power supply system “off-grid”).

It is noted that a different IIC may be provided for different voltage levels (e.g., different DC rails). In one example, two separate, but highly leveraged IICs may be provided. The first IIC is provided for interfacing with a low voltage (e.g., 12V) rail, and a second IIC is provided for interfacing with a high voltage rail.

The DC rail 242 is electrically connected to the primary unit of the backup power supply system and may also include one or more connections for electrically connecting any of a wide variety of electronic devices (the load 240) to power being supplied by the backup power supply system. The DC rail 242 also provides a connection to the primary electrical power source (e.g., the utility provider) via AC/DC converter 244.

During operation, current flows between the IIC and the battery module in two directions. When current flows from the battery module, the backup power supply system is in a discharge mode. When current flows from the IIC to the battery, the backup power supply system is in charge mode. During discharge mode, the backup power supply system provides power to the common DC power node between a power source and the load. During the charge mode (or online mode), the backup power supply system takes power from the common DC node to charge the battery modules. The common DC node may be implemented as a node where all power is to the specific load.

Accordingly, electrical power is provided from the primary power source to one or more electronic devices (the load 240), e.g., by operating in a “pass-through” mode. If the primary power source is disrupted (e.g., during a power failure), or degraded, the backup power supply system may come online to provide electrical power to the one or more electronic devices in the load 240 from the auxiliary power source (e.g., the battery modules 230).

Before continuing, it is noted that the backup power supply system may be used with any of a wide variety of computing systems or other electronic devices, and is not limited to use in a rack environment. For example, the backup power supply system may also be utilized with stand-alone personal desktop or laptop computers (PC), workstations, consumer electronic (CE) devices, or appliances, to name only a few examples.

In addition to providing a backup source of power when the primary power source is unavailable (e.g., during a power outage), the backup power supply system also provides communications for reporting and management.

FIG. 2b is an example of a communication map 250 for the backup power system. A common interface may be provided between the battery module 230 and the IIC 210 as well as between the IIC 210 and the IM 220. The manager 260 serves as an interface for the backup power supply system and enables multiple 1 U chassis of the backup power supply system to be used in parallel. The manager 260 also communicates any monitoring, alerts, and other messages with the datacenter management (e.g., via software).

In an embodiment, the manager 260 may display or otherwise generate output for a user (and may also receive input from a user). For purposes of illustration, a user interface may be provided which includes light-emitting diode (LED) status indicators. The status indicators may be lit to indicate whether power is being supplied by the primary power source or by the auxiliary source (or a combination thereof), or to indicate performance, problems, etc.

Of course the user interface is not limited to LED status indicators, and may include any of a wide variety of input/output (I/O). User interface may also be utilized for any of a wide variety of input and/or output. Other examples include, but are not limited to, a reset function, a test feature, power on/off, etc.

In any event, this input/output may be relayed between the components of the primary unit of the backup power supply system (e.g., IM 220, IIC 210, and battery module 230) and the user via manager 260 by signal wiring or wireless communications.

The communications circuitry may include a processor (or processing units) operatively associated with computer readable storage or memory. During operation, computer readable program code (e.g., firmware and/or software) may be stored in memory and executed by the processor to implement one or more of the capabilities provided by the backup power supply system.

The program code may also be communicatively coupled with one or more sensing modules or monitors. In an exemplary embodiment, the sensing modules may monitor any of a wide variety of different battery parameters. Example battery parameters may be written to and/or read from registers stored in association with the battery module 230 and/or the IIC 210. Examples of battery parameters are summarized in Table 1, which is an example of a battery module register; and Table 2, which is an example of an IIC register.

TABLE 1

| | | | | | Bit | | | |
|---|---|---|---|---|---|---|---|---|
| Sec | Loc | Access | Reg Desc | Bit | Desc | Min | Max | Units |
| 0 | 0x00 | R | Proc info | 0-3 | Vendor | 0 | 15 | NA |
| | 0x02 | R | Status | 4-7 | Type | 0 | 15 | NA |
| | . . . | | | | | | | |
| 1 | 0x10 | R | Min Volt | NA | NA | 0 | NA | V |
| | 0x12 | R | Nom Volt | NA | NA | 0 | NA | V |
| | . . . | | | | | | | |
| 2 | 0x20 | R | Min Temp | NA | NA | 0 | NA | C |
| | 0x22 | R | Max | NA | NA | 0 | 0 | C |
| | | | Temp | | | | | |
| | . . . | | | | | | | |
| 3 | 0x30 | R | Charge | 0-3 | Stage0 | 0 | 0 | NA |
| | 0x32 | R | Discharge | 4-7 | Stage1 | 0 | 0 | NA |
| | . . . | | | | | | | |
| 4 | 0x50 | RW | Reserve | NA | NA | NA | NA | NA |
| | 0x52 | R | Reserve | NA | NA | NA | NA | NA |
| | . . . | | | | | | | |

TABLE 2

| Loc | Access | Reg Desc | Bit | Bit Desc | Min | Max | Units |
|---|---|---|---|---|---|---|---|
| 0x00 | R | Proc info | 4-7 | Type | | | |
| 0x02 | R | Status | 0 | Output | 0 | 1 | NA |
| | | | 1 | Input | 0 | 1 | NA |
| | | | 2 | Enable | 0 | 1 | NA |
| | | | 3-5 | Vendor | 0 | 1 | NA |
| | | | . . . | . . . | . . . | . . . | . . . |
| . . . | | | | | | | |

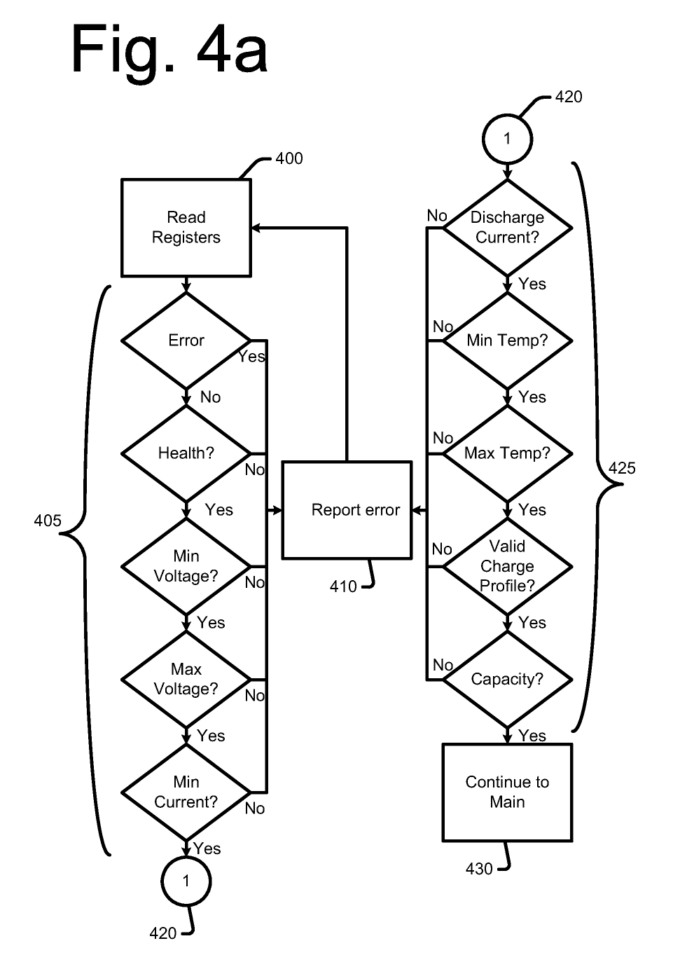

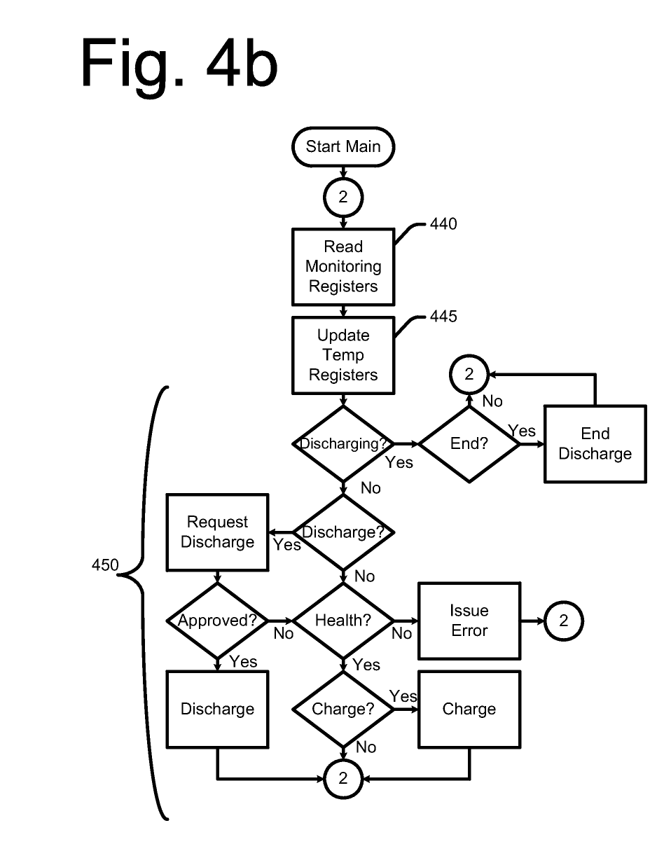

The battery registries may be implemented by the battery module 230 and IIC 210 to enable use of different battery technologies and cell counts. Example flow charts for the converter system to utilize the interface are shown in FIGS. 4a-b. The IIC 210 uses the register and logic similar to the flow charts to customize its operation to the specific battery pack chemistry and cell count. This interface between the battery module 230 and IIC 210 enable a common set of characteristics to be reconciled such that any of a wide variety of different battery chemistry or number of cells can be used with the IIC 210. The IIC register set enables the IIC 210 to interface properly with the power system.

The battery registries and modularity of the battery modules may also enable the backup power supply to continuing to providing power to electronic devices in other domains (i.e., a group of electronic devices on the backup power supply) even if one domain is lost due to failure of one of a plurality of battery modules. In one example, the battery registries may enable the user to configure the backup power supply so that one (or a group of) battery module provides power to identified domains. Accordingly, when one (or a group of) battery module is lost, only the domain powered by that battery module loses power during a power outage.

Some of the functions enabled by the common IIC and battery interface include, but are not limited to: correct charging, pack monitoring, temperature reporting, sizing capacity available, controlled discharge requests, ensuring pack compatibility, proper discharging, and assistance with battery pack health determinations.

In an embodiment, there are two general outputs for the battery module. The first is an early stop discharge warning. This signal goes low when the battery module has nearly discharged its entire capacity. The second signal is a final stop discharge warning and indicates that the discharge must cease. These signals are interrupt inputs for the IIC 210.

Some example high level functions which may be implemented by the manager 260 using the IIC registers include, but are not limited to: fan control, controlled discharge interfacing, charging power budgeting, monitoring and reporting, discharge power budgeting, and system interfacing.

Implementation of the registries also enables the user to configure the backup power supply system with customized power configuration(s). Exemplary power configurations may provide for longer ride through times, for example, by setting different output power levels for different electronics devices. In one example, only high priority electronic devices (as configured by the user) may be provided power during a power outage (when the battery module is providing power), while less important electronic devices may be allowed to power off or power down (e.g., fan speeds may be reduced) during a power failure. For example, supplemental cooling fans and backup devices may be allowed to power off so that the ride through time (time that power is provided during an outage) can be extended for critical devices (e.g., high priority servers) beyond what a typical UPS may provide during an outage. provides power from the battery module only for a predetermined output level.

It is noted that the registries in Tables 1 and 2 are merely exemplary of registries and entries which may implement various functionality of the backup power supply system, and are not intended to be limiting. The registries are not limited to any particular format or content. Other functionality may also be implemented with other registries and/or registry entries, not shown, using the program code and registries described herein to provide a wide range of different functions and operability.

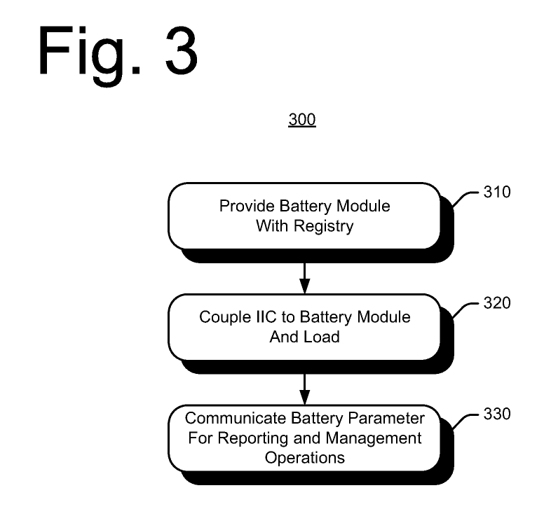

FIG. 3 is a flowchart illustrating exemplary operations 300 which may be implemented for controlling backup power supply systems. Operations 300 may be embodied as logic instructions (e.g., firmware) on one or more computer-readable medium in the remote unit of the UPS device. When executed on a processor in the remote unit of the UPS device, the logic instructions cause a general purpose computing device to be programmed as a special-purpose machine that implements the described operations. The operations may also be implemented in hardware (e.g., device logic), or a combination of hardware and firmware. In an exemplary implementation, the components and connections depicted in the figures may be used for the described operations.

In operation 310, at least one battery module is provided having a first register with at least one battery parameter. In operation 320, an intelligent interface converter (IIC) is coupled between the at least one battery module and an electrical load. The IIC has a second register with at least one battery parameter. In operation 330, the at least one battery parameter is communicated to a user for reporting and management operations.

By way of illustration and without intending to be limiting, reporting and management operations may include correct charging, pack monitoring, temperature reporting, sizing capacity available, controlled discharge requests, ensuring pack compatibility, proper discharging, assistance with battery pack health determinations, fan control, controlled discharge interfacing, charging power budgeting, monitoring and reporting, discharge power budgeting, and system interfacing.

The operations shown and described herein are provided to illustrate exemplary implementations of controlling backup power supply systems. It is noted that the operations are not limited to the ordering shown. For example, operations may be ordered one before the other or performed simultaneously with one another.

Still other operations not shown may also be implemented. For example, operations may also include interfacing the IIC with the battery module based on battery parameters in the first register. Operations may also include controlling one or more function for the electrical load based on battery parameters in the first and second registers.

FIGS. 4a-b are flowcharts showing example operations of an IIC. In this example, the IIC accesses the battery module register to ensure compatibility for different battery modules in the backup power supply system. In FIG. 4a, the IIC reads the battery module registers at 400 and checks for a variety of different operating parameters 405. If there are any errors, those errors are reported at 410. Otherwise, operations continue at 420 to check various operating conditions 425. If there are any errors in the operating parameters, those are reported at 410. Otherwise, operations continue at 430, which is shown in more detail in FIG. 4b. In FIG. 4b, the IIC reads monitoring registers at 440 and temperature registers at 445. The IIC determines a charge/discharge state, and battery health by operations illustrated generally by operational blocks 450.

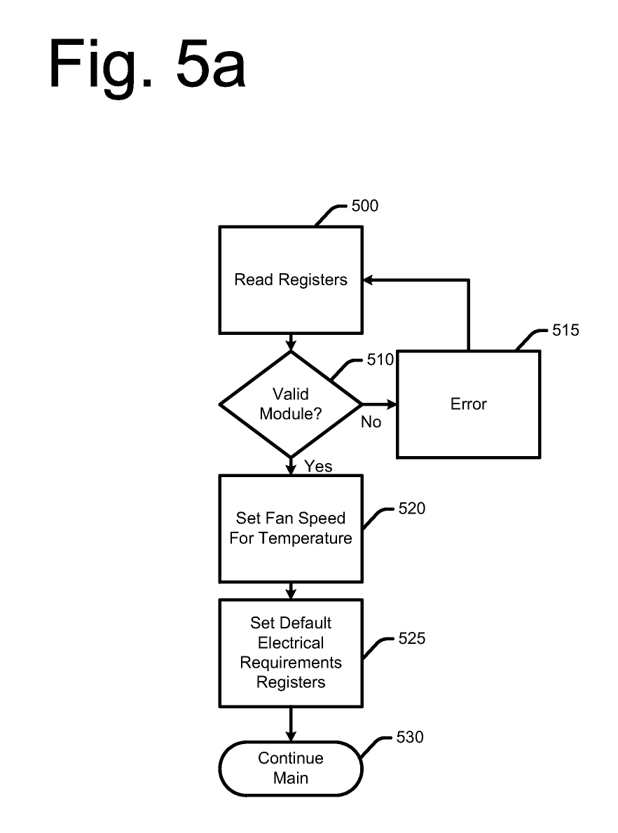

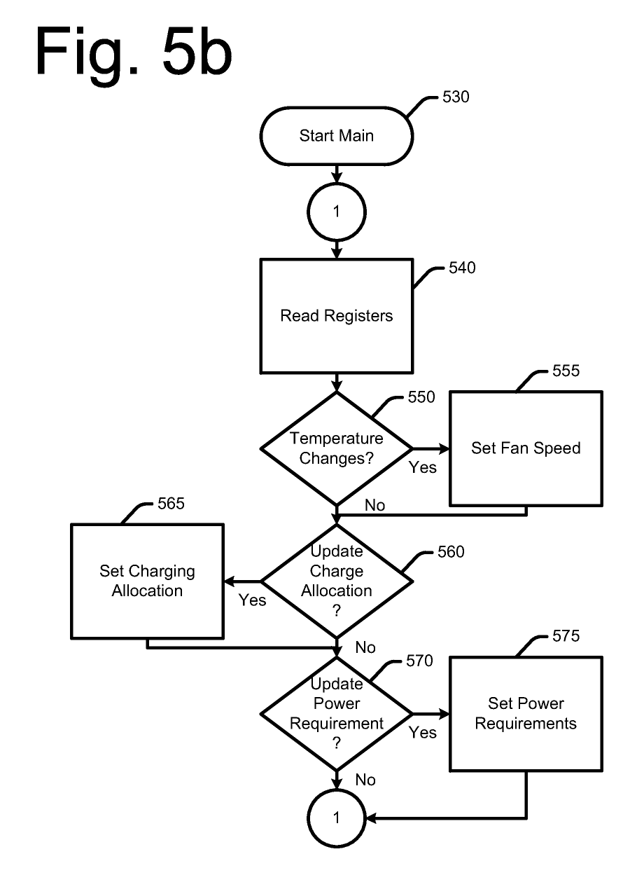

FIGS. 5a-b are flowcharts showing example operations of an IM. In this example, the IM accesses the registers at the battery module and IIC to provide a common method to ensure correct function of the backup power supply system. In FIG. 5a, the IM reads the IIC register and/or battery module register at 500 and determines whether the battery module is valid at 510. Error(s) are reported at 515. In this example if there are no errors, then the fan speed is set for the operating temperature (520), and default electrical requirements registers are set (525). Operations then continue at 530 as illustrated in more detail by FIG. 5b. In FIG. 5b, the IM reads the registers 540 and determines if there have been temperature changes at 550. If there are temperature changes, those may be addressed by setting the fan speed at 555. In any event, the charge allocation may be checked at 560 and set at 565. Similarly, power requirement may be checked at 570 and set at 575.

It is noted that the flowcharts in FIGS. 4a-b and 5a-b are merely exemplary of various functionality of the backup power supply system and are not intended to be limiting. Other functionality may also be implemented with other operations, not shown, using the program code and registries described herein to provide a wide range of different functions and operability.

The exemplary embodiments shown and described are provided for purposes of illustration and are not intended to be limiting. Still other embodiments of backup power supply systems and methods are also contemplated.

What is claimed is:

1. A backup power supply system comprising:
a battery module having a first register with at least one battery parameter;
an intelligent interface converter (IIC) communicatively coupled to the battery module, the IIC having a second register with at least one battery parameter; and
wherein the IIC connects via an interconnect and management (IM) to an electrical load, the IM communicating report and management parameters based on the at least one battery parameter in the first and second registers, wherein the registers provide customized power configuration for when the backup power supply system is providing power.

2. The backup power supply system of claim 1, wherein customized power configuration provides power from the battery module only for high priority electronics, and wherein low priority electronics power off.

3. The backup power supply system of claim 1, wherein customized power configuration provides power from the battery module only for a predetermined output level.

4. The backup power supply system of claim 1, wherein customized power configuration provides power from the battery module to lengthen ride-through times.

5. The backup power supply system of claim 1, further comprising a common interface between the IIC and the battery module for interchanging battery modules having different cell chemistry and number of cells with the same IIC.

6. The backup power supply system of claim 1, wherein the IIC connects to a DC rail through the IM so that the battery module is off-grid, the DC rail includes a low voltage rail or a high voltage rail.

7. The backup power supply system of claim 1, wherein the battery module is sized to fit in a 1 U rack chassis and electrically connected in parallel with other battery modules in a rack system.

8. The backup power supply system of claim 1, wherein at least two interrupts are indicated for the IIC, wherein one of the at least two interrupts is an early stop discharge warning, and wherein one of the at least two interrupts is a final stop discharge warning.

9. The backup power supply system of claim 1, wherein the IIC receives battery parameters from the first register to interface with the battery module.

10. The backup power supply system of claim 9, wherein interfacing with the battery module includes at least one of: charging, battery health monitoring, temperature reporting, controlled discharge, battery compatibility, sizing.

11. The backup power supply system of claim 1, wherein the IM receives battery parameters from the first and second registers to control one or more function for the electrical load.

12. The backup power supply system of claim 11, wherein the one or more function for the electrical load is at least one of: fan control, controlled discharge, budgeting charging power, budgeting discharging power, monitoring and reporting, and system interfacing.

13. A backup power supply comprising:
at least one battery module having a first register with at least one battery parameter;
an intelligent interface converter (IIC) communicatively coupled between the at least one battery module and an electrical load, the IIC having a second register with at least one battery parameter; and
wherein the at least one battery parameter is communicating to a user for reporting and management operations, wherein the registers provide customized power configuration for when the backup power supply system is providing power.

14. The backup power supply system of claim 13, wherein the same IIC is configured to couple with at least one more battery module for scalability.

15. The backup power supply system of claim 13, further comprising a common interface between the IIC and the battery module for interchanging battery modules having different cell chemistry and number of cells with the same IIC.

16. The backup power supply system of claim 13, wherein the IIC receives battery parameters from the first register to interface with the battery module.

17. The backup power supply system of claim 13, further comprising an interconnect and management (IM) configured to control one or more function for the electrical load based on battery parameters in the first and second registers.

18. A method of controlling a backup power supply comprising:
providing at least one battery module having a first register with at least one battery parameter;
coupling an intelligent interface converter (IIC) between the at least one battery module and an electrical load, the IIC having a second register with at least one battery parameter; and
communicating the at least one battery parameter to a user for reporting and management operations, wherein the registers provide customized power configuration for when the backup power supply system is providing power.

19. The method of claim 18, further comprising interfacing the IIC with the battery module based on battery parameters in the first register, and controlling one or more functions for the electrical load based on battery parameters in the first and second registers.

20. The method of claim 18, further comprising continuing to provide power to electronic devices in other domains even if one domain is lost due to failure of one of a plurality of battery modules.
